(19) United States
(12) Patent Application Publication
(10) Pub. No.: US 2010/0010817 A1
(43) Pub. Date: Jan. 14, 2010

(54) System and Method for Improving the Performance of Speech Analytics and Word-Spotting Systems

(76) Inventor: Veeru Ramaswamy, Jackson, NJ (US)

Correspondence Address: STOLL KEENON OGDEN PLLC, 2000 PNC PLAZA, 500 WEST JEFFERSON STREET, LOUISVILLE, KY, 40202-2828, US

(21) Appl. No.: 12/168,985

(22) Filed: Jul. 8, 2008

(51) Int. Cl. G10L 11/00

(52) U.S. Cl. 704/270.1

(57) ABSTRACT

A System and Method for Improving the Performance of Speech Analytics and Word-Spotting Systems is provided wherein a digitized signal originates from a input client device belonging to a customer, the signal being then passed to a network which passes the signal to both of an output client device belonging to a customer service rep and a call recorder. The call recorder compresses the signal using CELP-based technology such as MASC® technology and then sends the compressed signal to a speech analytics engine before being processed with or without a signal processing filter. The speech analytics engine receives the signal and upon also receiving a query, the speech analytics engine operates on the signal in response to the query, thereby outputting one or more desired voice outputs to an application to include a query application.

### BRIEF DESCRIPTION OF THE DRAWINGS

FIG. 1 shows an embodiment for a System and Method for Improving the Performance of Speech Analytics and Word-Spotting Systems wherein a G.711/PCM signal is utilized.

FIG. 2 shows an embodiment for a System and Method for Improving the Performance of Speech Analytics and Word-Spotting Systems wherein a standards-based means signal is utilized.

### MULTIPLE EMBODIMENTS AND ALTERNATIVES

Multiple embodiments of a System and Method for Improving the Performance of Speech Analytics and Word-Spotting Systems 10 are provided.

In traditional Public Switched Telephone Networks (PSTN), Integrated Services Digital Network (ISDN), wireless, or Internet Protocol (IP) networks, voice signals such as G.711, G.72x, GSM-AMR and CDMA-EVRC are recorded and saved in a call recorder after the voice signals are passed to a speech analytics engine. This is done in order to avoid either the artifacts that are created by compression schemes, or in order to preserve the maximum voice quality for recognition purposes. When uncompressed voice signals are passed through a speech analytics engine, the speech analytics engine typically creates voice footprints that are used for comparisons of a search query. The search query is generated by a query application and it is typically a term or phrase in combination with a Boolean operation such as AND, OR or NOT.

For embodiments wherein G.711 signals are captured, these signals are selectably, as desired, compressed. Further embodiments include those wherein compression is performed utilizing CELP-based technology such as MASC® technology as described in U.S. patent application Ser. No. 10/676,491. MASC® processing has been found to perform better and yield higher FOM scores because of the inherent noise reduction techniques that are incorporated into the MASC® compression algorithm. For embodiments utilizing G.711 signals, with their inherent noise, that are captured, MASC® performs noise reduction to enhance the performance and FOM scores. By doing so, these MASC® compressed signals, when passed to the speech analytics engine after being decompressed, are found to yield Figure of Merit (FOM) results superior to non-MASC® schemes. This case exists for circumstances wherein the original signals that were used to create the model for the speech analytics engine are NOT trained by the MASC®-processed signals. Further improvements in FOM results are found in embodiments wherein the MASC®-decompressed signals are used to train the speech analytics engine.

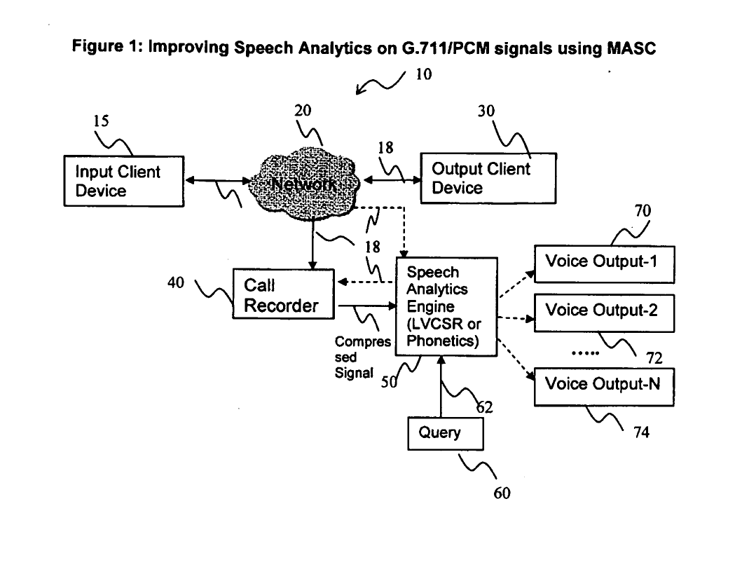

In further detail, with continued reference to FIG. 1, embodiments off a G.711 or a PCM uncompressed System for Improving the Performance of Speech Analytics and Word-Spotting Systems 10 comprise a digitized audio signal 18, one or more input client devices 15, a network 20 one or more output client devices 30, a call recorder 40 including a compressor/encoder, a speech analytics engine 50 and a query application 60. Furthermore, the call recorder 40 includes a decompressor/decoder, as desired. Alternative embodiments provide that the speech analytics engine 50 includes the decompressor/decoder to decompress the compressed signal received from the call recorder 40. The speech analytics engine 50 is selectably chosen, as desired, from the group LVCSR, Phonetics. The network 20 is selected, as desired, from the group PSTN, ISDN, IP. Embodiments provide that the compressor/encoder utilizes MASC® technology. The digitized audio signal 18 is selected, as desired, from the group PCM, G.711.

With respect to the system described above, a Method for Improving the Performance of Speech Analytics and Word-Spotting Systems comprises the steps of:

1. Providing a digitized audio signal 18 originating from one or more input client devices 15, the signal 18 being passed to a network 20.

2. The signal 18 being then received from the network 20 by both of one or more output client devices 30 and a call recorder 40.

3. The call recorder 40 compressing the signal 18 using a compressor/encoder and then sending the compressed signal 18 to a speech analytics engine 50.

4. The speech analytics engine 50 creating a voice footprint upon receiving the signal 18.

5. Upon receiving a query 62 from a query application 60, the speech analytics engine 50 operating on the voice footprint in response to the query 62, thereby outputting one or more voice outputs 70-74 from the speech analytics engine 50.

6. The voice outputs 70-74 being returned to any application, as desired, to include the query application 60.

The Method taught above includes embodiments utilizing various choices and combinations within the system 10 as taught above. For example, not meant to be limiting, embodiments of the system and method 10 include those wherein the input client devices 15 are utilized by customers, and the output client devices 30 are utilized by customer service representatives. The speech analytics engine 50 is selectably chosen, as desired, from the group LVCSR, Phonetics. The network 20 is selected, as desired, from the group PSTN, ISDN, IP. Embodiments provide that the compressor/encoder utilizes MASC® technology. Furthermore, embodiments include those wherein the digitized audio signal 18 is selected, as desired, from the group PCM, G.711.

Embodiments include those having standards-based means signals to include G.72x means signals, which are traditionally used in telephony based on IP or PSTN networks. Embodiments include those wherein the voice call is captured and recorded natively in the standards-based format. To improve/enhance the FOM scores, MASC® technology as described in U.S. patent application Ser. No. 10/676,491, in combination with other post-processing filtering (signal processing) technology will perform or provide better FOM accuracy than the original standards-based signals. Such embodiments include those wherein the query remains the same, being most often found as a text or voice input, but more commonly found as text. Embodiments include those wherein a voice footprint (to be discussed in further detail below), which was originally formed by the speech analytics engine, is processed using MASC® technology along with post processing filtering. As discussed above previously in teaching the G.711 embodiments, the MASC® compressed signals, when passed to the speech analytics engine after being decompressed, are found to yield Figure of Merit (FOM) results superior to non-MASC® schemes. This case exists for circumstances wherein the original signals that were used to create the model for the speech analytics engine are not trained by the MASC®-processed signals. Further improvements in FOM results are found in embodiments wherein the MASC®-decompressed signals are used to train the speech analytics engine.

Even higher FOM scores are achieved when utilizing embodiments having MASC® processing combined with the post-processing filter combination in that order.

The training and recognition for Large Vocabulary Continuous Speech Recognition-based (LVCSR-based) and Phonetic-based speech analytics engines is performed differently. LVCSR is typically based on a Hidden Markov Model (HMM) for training and recognition of spoken words. LVCSR-based speech analytic engines do not split the spoken words into phonemes for training and recognition. Instead, the engines look for entire words, as is, for training and recognition. Phonetic-based speech analytic engines split the words into phoneme units or sometimes even into sub-phoneme units, as desired, and then the speech analytic engine is trained with those phonemes to create a matrix of phoneme probabilities and the identification/recognition is done based on the input query to match the threshold or probabilities of the phonemes. These phoneme probabilities are typically referred to as the voice footprint.

The use of MASC® processing in noise reduction applies not only to G.711 embodiments as above, but also to embodiments utilizing standards-based means to include G.72x means. As written above, for embodiments utilizing and capturing G.711 signals, with their inherent noise, MASC® performs noise reduction to enhance the performance and FOM scores. In contrast, for embodiments utilizing G.72x compression schemes, there are two forms of noise that typically appear embedded within the signals. The first form of noise is ambient noise that is recorded when the recording is being made. Such ambient noise is typically due to car noise, street noise, babble noise and other forms of background sounds. The second form of noise is quantization noise typically occurring when digitizing an audio signal or when the audio signal is reduced to a lower resolution, such as, for example, from 8-bit samples to 4-bit or 2-bit samples. Apart from the ambient noise, which is handled inherently by the MASC® technology, the quantization noise is typically injected as artifacts while performing a standards-based means compression. For best FOM scores, the quantization noise is taken care of by the combination of compressors and filters; such as, for example, compressors utilizing MASC® technology combined with signal processing filtering.

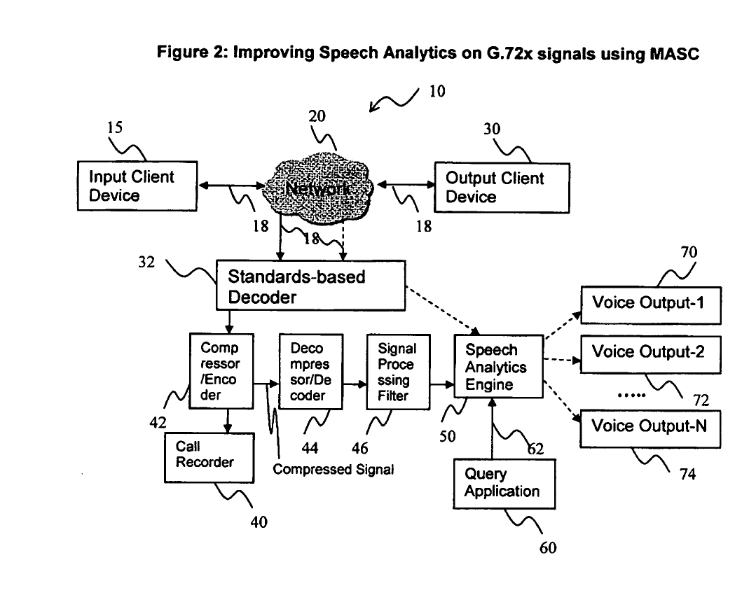

In further detail, with continued reference to FIG. 2, a System for Improving the Performance of Speech Analytics and Word-Spotting Systems 10 comprises a digitized audio signal of standards-based means, wherein the standards-based means is selectably chosen, as desired, from the group PCM, G.722, G.723, G.726, G.729, GSM-AMR, CDMA-EVRC. Embodiments further comprise one or more input client devices 15, a network 20, one or more output client devices 30, a standards-based means decoder 32, a call recorder 40, a compressor/encoder 42, a decompressor/decoder 44, a signal processing filter 46, a speech analytics engine 50 and a query application 60. The speech analytics engine 50 is selectably chosen, as desired, from the group LVCSR, Phonetics. The network 20 is selected, as desired, from the group PSTN, ISDN, IP. Embodiments provide that either or both of the compressor/encoder 42 and the decompressor/decoder 44 utilize MASC® technology.

With continued reference to FIG. 2, the standards-based means system 10 provides that each of the call recorder 40, compressor/encoder 42, decompressor/decoder 44, signal processing filter 46 and speech analytics engine 50 are placed into two groups being a first group and a second group. Embodiments provide that various combinations of each of the call recorder 40, compressor/encoder 42, decompressor/decoder 44, signal processing filter 46 and speech analytics engine 50 are made wherein each is in either the first group or the second group, the first group being either physically collocated or remotely located from the second group. For example, not meant to be limiting, an embodiment is provided wherein the call recorder 40 and the compressor/encoder 42 are in the first group and the decompressor/decoder 44, filter 46, and speech analytics engine 50 are placed into the second group. Going on with this example, further embodiments include those wherein the first group and the second are physically collocated, such that the two groups are placed within a single physical structure, by either physical location or even merely by function. By way of further example with respect to this example, other embodiments include those wherein the two groups are remotely located such that the first group is physically separate from second group. In such embodiments, the arrows drawn in FIG. 2 between components 40-50 represent a signal path, typically over a network such as network 20.

With respect to the standards-based means system 10 taught above, a Method for Improving the Performance of Speech Analytics and Word-Spotting Systems comprises the steps of:

1. Providing a digitized standards-based means audio signal 18 originating from one or more input client devices 15, the signal 18 being passed to a network 20.

2. The signal 18 being then received from the network 20 by both of one or more output client devices 30 and a standards-based means decoder 32.

3. The standards-based means Decoder 32 decompressing the compressed standards-based means signal 18 thereby yielding a decompressed PCM signal, the standards-based means decoder 32 then sending the decompressed PCM signal to a compressor/encoder 42.

4. The compressor/encoder 42 compressing the decompressed PCM signal and sending the compressed signal to a call recorder 40.

5. The call recorder 40 sending the signal to a decompressor/decoder 44.

6. The decompressor/decoder 44 decompressing the signal and sending the decompressed signal to a signal processing filter 46 yielding a processed PCM WAV signal.

7. The signal processing filter 46 sending the processed PCM WAV signal to a speech analytics engine 50.

8. The speech analytics engine 50 creating a voice footprint upon receiving the processed signal.

9. Upon receiving a query 62 from a query application 60, the speech analytics engine 50 operating on the voice footprint in response to the query 62, thereby outputting one or more Voice Outputs 70-74 from the speech analytics engine 50.

10. The voice outputs 70-74 being returned to any application, as desired, to include the query application 60.

The speech analytics engine 50 is selectably chosen, as desired, from the group LVCSR, Phonetics. The network 20 is selected, as desired, from the group PSTN, ISDN, IP. Embodiments provide that either or both of the compressor/encoder 42 and the decompressor/decoder 44 utilize MASC technology. With continued reference to FIG. 2, Embodiments of the system and method 10 include those wherein the standards-based means is selected from the group PCM, G.722, G.723, G.726, G.729, GSM-AMR, CDMA-EVRC. Furthermore, the function of the compressor/encoder 42 is incorporated within, or physically separate from and in any order, as desired, the call recorder 40.

As shown in FIG. 2, the standards-based means method 10 provides that each of the Call Recorder 40, compressor/encoder 42, decompressor/decoder 44, signal processing filter 46 and Speech Analytics Engine 50 are placed into two groups being a first group and a second group. Embodiments provide that various combinations of each of the Call Recorder 40, compressor/encoder 42, decompressor/decoder 44, signal processing filter 46 and Speech Analytics Engine 50 are made wherein each is in either the first group or the second group, the first group being either physically collocated or remotely located from the second group. For example, not meant to be limiting, a method embodiment is provided wherein the Call Recorder 40 and the compressor/encoder 42 are in the first group and the decompressor/decoder 44, filter 46, and Speech Analytics Engine 50 are placed into the second group. Going on with this example, further method embodiments include those wherein the first group and the second are physically collocated, such that the two groups are placed within a single physical structure, by either physical location or even merely by function. By way of further example with respect to this example, other method embodiments include those wherein the two groups are remotely located such that the first group is physically separate from second group. In such embodiments, the arrows drawn in FIG. 2 between components 40-50 represent a signal path, typically over a network such as network 20.

I claim:

1. A System for Improving the Performance of Speech Analytics and Word-Spotting Systems comprising,
A digitized audio signal,
One or more input client devices,
A network,
One or more output client devices,
A call recorder including a compressor/encoder,
A speech analytics engine; and,
A query application.

2. The system of claim 1 further comprising the speech analytics engine chosen from the group LVCSR, Phonetics.

3. The system of claim 1, the network selected from the group PSTN, ISDN, wireless, IP.

4. The system of claim 1, the compressor/encoder comprising MASC® technology.

5. The system of claim 1, the digitized audio signal selected from the group PCM, G.711.

6. A Method For Improving the Performance of Speech Analytics and Word-Spotting Systems comprising the steps of:
Providing a digitized audio signal originating from one or more input client devices, the signal being passed to a network,
The signal being then received from the network by both of one or more output client devices and a call recorder,
The call recorder compressing the signal using a compressor/encoder and then sending the compressed signal to a speech analytics engine,
The speech analytics engine creating a voice footprint upon receiving the signal,
Upon receiving a query from a query application, the speech analytics engine operating on the voice footprint in response to the query, thereby outputting one or more voice outputs from the speech analytics engine; and,
The voice outputs being returned to any application, to include the query application.

7. The Method of claim 6 further comprising the speech analytics engine chosen from the group LVCSR, Phonetics.

8. The Method of claim 6, the network selected from the group PSTN, ISDN, wireless, IP.

9. The Method of claim 6, the compressor/encoder comprising MASC® technology.

10. The Method of claim 6, the digitized audio signal selected from the group PCM, G.711.

11. A System for Improving the Performance of Speech Analytics and Word-Spotting Systems comprising,
A digitized audio signal of standards-based means,
One or more input client devices,
A network,
One or more output client devices,
A standards-based means decoder,
A call recorder,
A compressor/encoder,
A decompressor/decoder,
A signal processing filter,
A speech analytics engine; and,
A query application.

12. The system of claim 11 further comprising the speech analytics engine chosen from the group LVCSR, Phonetics.

13. The system of claim 11, the network selected from the group PSTN, ISDN, wireless, IP.

14. The system of claim 11, either or both of the compressor/encoder and the decompressor/decoder comprising MASC® technology.

15. The system of claim 11 wherein each of the call recorder, compressor/encoder, decompressor/decoder, signal processing filter and speech analytics engine are placed into two groups being a first group and a second group, wherein each is in either the first group or the second group, the first group being either physically collocated or remotely located from the second group.

16. The system of claim 11 wherein the function of the compressor/encoder is incorporated within, or physically separate from and in any order, the call recorder.

17. The system of claim 11 wherein the standards-based means is selected from the group PCM, G.722, G.723, G.726, G.729, GSM-AMR, CDMA-EVRC.

18. A Method For Improving the Performance of Speech Analytics and Word-Spotting Systems comprising the steps of:
Providing a digitized standards-based means audio signal originating from one or more input client devices, the signal being passed to a network,
The signal being then received from the network by both of one or more output client devices and a standards-based means decoder,
The standards-based means decoder decompressing the compressed standards-based means signal thereby yielding a decompressed PCM signal, the standards-based means decoder then sending the decompressed PCM signal to a compressor/encoder,
The compressor/encoder compressing the decompressed PCM signal and sending the compressed signal to a call recorder,
The call recorder sending the signal to a decompressor/decoder,
The decompressor/decoder decompressing the signal and sending the decompressed signal to a signal processing filter yielding a processed PCM WAV signal,
The signal processing filter sending the processed PCM WAV signal to a speech analytics engine,
The speech analytics engine creating a voice footprint upon receiving the processed signal,
Upon receiving a query from a query application, the speech analytics engine operating on the voice footprint in response to the query, thereby outputting one or more voice outputs from the speech analytics engine; and,
The voice outputs being returned to any application, to include the query application.

19. The method of claim 18 further comprising the speech analytics engine chosen from the group LVCSR, Phonetics.

20. The method of claim 18, the network selected from the group PSTN, ISDN, wireless, IP.

21. The method of claim 18, either or both of the compressor/encoder and the decompressor/decoder comprising MASC® technology.

22. The method of claim 18, the standards-based means selected from the group PCM, G.722, G.723, G.726, G.729, GSM-AMR, CDMA-EVRC.

23. The method of claim 18, wherein each of the call recorder, compressor/encoder, decompressor/decoder, signal processing filter and speech analytics engine are placed into two groups being a first group and a second group, wherein each is in either the first group or the second group, the first group being either physically collocated or remotely located from the second group.
